(19) United States
(12) Patent Application Publication
(10) Pub. No.: US 2008/0147545 A1
(43) Pub. Date: Jun. 19, 2008

(54) INFORMATION PROCESSING DEVICE DEALING WITH SETTLEMENT INFORMATION ON A COMMERCIAL TRANSACTION

(75) Inventor: Naoki KAZAGOSHI, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/039,874

(22) Filed: Feb. 29, 2008

Related U.S. Application Data
(63) Continuation of application No. PCT/JP2005/015947, filed on Aug. 31, 2005.

(51) Int. Cl. G06Q 40/00

(52) U.S. Cl. 705/40

(57) ABSTRACT

An information processing device communicates with a first server that provides transaction settlement information, communicates with a second server that converts the transaction settlement information into a predetermined format, receives the transaction settlement information from the first server, records the received transaction settlement information, records identifying information for identifying the second server, transmits the transaction settlement information to the second server on the basis of the recorded identifying information, receives, from the second server, converted settlement information converted by the second server into the predetermined format from the transaction settlement information, and records the thus-received converted settlement information.

### CROSS-REFERENCE TO RELATED APPLICATIONS

This is a continuation of Application PCT/JP2005/015947 filed on Aug. 31, 2005, now pending, the contents of which are herein wholly incorporated by reference.

### BACKGROUND OF DISCLOSURE

The present invention relates to an information processing device dealing with settlement information on a commercial transaction.

Over the recent years, there have been increasingly accounting divisions, finance divisions and purchasing divisions, which utilize online banking and Web shopping on a day-to-day basis. It is, however, time-consuming that a user re-inputs a result of transaction on the Web to accounting software utilized. Further, the online banking and the Web shopping widely spread over ordinary households. The result of the transaction needs, however, transcribing onto housekeeping accounts book software. This causes troublesomeness and a mistake in the transcription. Patent document 1 discloses that settlement information on the commercial transaction is provided in a status enabling the information to be digitally managed. Moreover, there exists a function of outputting particulars of the transaction on the online banking as data oriented to a specified piece of software. If the user does not utilize the very software, however, the user can not use the data. Furthermore, if the user employs different pieces of accounting software and housekeeping accounts book software, the user needs to re-input the data. Therefore, the troublesomeness of re-inputting the data is not obviated. Further, an output function must be individually generated for every piece of specified software at the site for conducting the Web transaction, and hence it is impossible to support multiple pieces of software. Moreover, if the supported software is upgraded in version, the output function, which supports the upgraded version, is required to be provided.

[Patent document 1] Japanese Patent Laid-Open Publication No. 2003-76932

### SUMMARY

Accordingly, the conventional arts need to provide a multiplicity of output functions and are disabled to convert the data without any increase in costs. The present invention aims at providing a technology of converting online the data of the result of the transaction on the Web into data oriented to various types of accounting software and housekeeping accounts book software utilized by the users.

The present invention adopts the following means in order to solve the problems given above.

(1) Namely, an information processing device (the present information processing device) according to the present invention is an information processing device communicating with a first server that provides transaction settlement information and communicating with a second server that converts the transaction settlement information into a predetermined format, the device comprising: a receiving unit receiving the transaction settlement information from the first server; a recording unit recording the received transaction settlement information; a identifying information recording unit recording identifying information for identifying the second server; a settlement information transmitting unit transmitting the transaction settlement information to the second server on the basis of the recorded identifying information; a receiving unit receiving, from the second server, converted settlement information converted by the second server into the predetermined format from the transaction settlement information; and a recording unit recording the thus-received converted settlement information. Based on this configuration, the data of the transaction result is converted into the predetermined format. Accordingly, the user has no necessity of re-inputting by himself or herself the transaction result received from an online transaction site. Consequently, it is possible to omit the re-inputting operation and to prevent a mis-input with which the re-inputting accompanies.

(2) Further, the information processing device may be configured to further comprise a querying unit querying a user about whether the transaction settlement information is converted into the predetermined format or not, wherein the settlement information transmitting unit, if the user consents that the transaction settlement information is converted into the predetermined format, transmits the transaction settlement information to the second server, but does not transmit, whereas if the user does not consent that the transaction settlement information is converted into the predetermined format, the transaction settlement information to the second server. This configuration enables the user to select as to whether the data of the transaction result is converted into the predetermined format or not.

(3) Still further, the present information processing device may be configured to further comprise a prompting unit prompting the user to select the second server as a transmitting destination of the transaction settlement information, wherein the settlement information transmitting unit transmits the transaction settlement information to the second server selected by the user but does not transmit the transaction settlement information to the second server that is not selected by the user. This configuration enables the user to select the server that converts the data of the transaction result into the predetermined format.

(4) Yet further, the present information processing device may be configured so that the predetermined format is a format, which is processing-enabled by software dealing with the transaction settlement information. This configuration enables the data of the transaction result to be converted into the data oriented to the software installed by the user.

(5) Still further, the present information processing device may be configured so that the identifying information recording unit records the identifying information corresponding to the predetermined format, and the second server is provided for every predetermined format. With this configuration, the server, which converts the data of the transaction result into the predetermined format, can be identified by the identifying information corresponding to the predetermined format.

(6) Moreover, the present information processing device may be configured so that the identifying information is identifying information on the Internet, and the second server is a Web server that provides services on the Internet.

Furthermore, the present invention may also be a method by which the information processing device and other devices, machines, etc execute any one of the processes described above. Still furthermore, the present invention may also be a program for making the information processing device and other devices, machines, etc realize any one of the processes described above. Yet furthermore, the present invention may also be a recording medium recorded with such a program that can be read by the computer etc.

According to the present invention, the data of the transaction result is converted online into the data oriented to the software utilized by the user, and it is therefore feasible to omit a user's operation of re-inputting the data of the transaction result and to prevent an input mistake in re-inputting.

### BRIEF DESCRIPTION OF THE DRAWINGS

FIG. 1 is a diagram of a whole configuration in an embodiment of the present invention.

FIG. 2 is a diagram showing an example of adding setting information of settlement plug-in software.

FIG. 3 is a diagram showing a case in which a transaction data converting site of a server 3 converts common transaction data into converting destination data.

FIG. 4 is a diagram showing a hardware configuration of a user terminal 1.

FIG. 5 is a flowchart showing a common transaction data converting process.

FIG. 6 is a diagram showing an example of a screen for ascertaining whether the common transaction data is converted into the data oriented to the software installed into the user terminal 1.

### DETAILED DESCRIPTION

A best mode (which will hereinafter be termed an embodiment) for carrying out the present invention will hereinafter be described with reference to the drawings. A configuration in the following embodiment is an exemplification, and the present invention is not limited to the configuration in the embodiment.

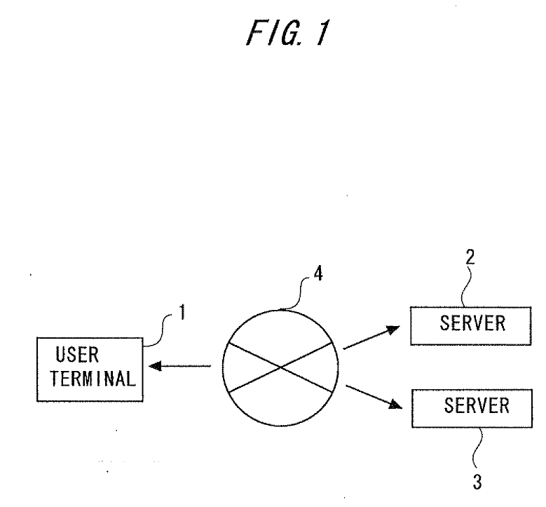

FIG. 1 is a diagram of a whole architecture in the embodiment of the present invention. The embodiment of the present invention has a user terminal 1 (corresponding to an [information processing device] according to the present invention) used when a user performs a transaction on a network, a server 2 (corresponding to a [first server] according to the present invention) including a transaction site on which to conduct the transaction with the user terminal 1, and a server 3 (corresponding to a [second server] according to the present invention) including a site for receiving, from the user terminal 1, data of a result of the transaction (which will hereinafter be referred to also as transaction data) conducted on the transaction site, then converting the transaction data into a predetermined output format, and providing the converted data to the user terminal 1. Further, the user terminal 1, the server 2 and the server 3 are each connected to a network 4.

The user terminal 1 can involve using, e.g., a personal computer connectable to the network 4. Moreover, the user terminal 1 can involve using, in addition to the personal computer, an information processing device connectable to the network 4, such as a PDA (Personal Digital Assistant), a mobile phone and CE (Consumer Electronics) equipment.

The user selects a commercial article on a screen and inputs transaction information by use of the user terminal 1. Herein, the user accesses the online transaction site to display a shopping page, wherein the user selects the commercial article and inputs user-related information and information on a remittance from a bank account. Namely, the user accesses the transaction site included in (administered by) the server 2 via the network 4 by employing the user terminal 1, in which the user purchases the commercial article and settles an account with the transaction. Further, the user accesses a site included in the server 3 via the network 4 by using the user terminal 1 and is thereby provided with a transaction data converting service. In the present embodiment, the Internet can be utilized as the network 4. Moreover, other than the Internet, the network 4 can be also built up by a communication line such as a telephone line, a private line, an optical communication network and a communication satellite.

The user terminal 1 includes a WWW (World Wide Web) Browser (which will hereinafter be simply termed the Browser). The user terminal 1 can access the site opened on the network 4 via the Browser. The site opened on the network 4 is specified by a unique URL (Uniform Resource Locator). The browser designates the URL, thereby enabling the access to the site opened on the network 4. Further, the Browser, when inputting a specified URL to the Browser, can be connected to the server that configures the site specified by the URL on the basis of a protocol described in the URL. The URL consists of a protocol for which to access the information existing on the network 4, a name of the server on the network 4 where the information exists, a directory stored with the information and a file name. The URL corresponds to identifying information according to the present invention.

Further, the Browser can receive a desired file described in the URL from the server. The Browser, after receiving the file, decodes the received file. Then, the Browser displays a screen defined by the file on a monitor of the user terminal 1. The file is described in, for example, a markup language such as HTML (HyperText Markup Language) and XML (Extensible Markup Language). Moreover, the Browser can also transmit the information inputted by the user to the connected server.

The user terminal 1 has plug-in software. The plug-in software is defined as a program for adding functions to the Browser program. The plug-in software may be read from a recording medium such as a flexible disc, a magneto-optic disc, a CD-ROM, a CD-R/W and a DVD and may also be downloaded from on the network 4. The Browser interprets the HTML file and, if there is a description for designating execution of the plug-in software, executes the plug-in software corresponding to a content of the description.

The plug-in software may be generated by a Browser developing maker, an accounting software maker, a housekeeping accounts book maker, etc. The following specifications for generating the plug-in software are opened to the public.

<Data Format in Common Transaction Format>

The transaction site transmits, to the user terminal 1, the transaction data based on a data format in a common transaction format opened to the public. The data format in the common transaction format is described in the markup language such as the HTML (HyperText Markup Language) and the XML (Extensible Markup Language). Herein, the data converted into the data format in the common transaction format opened to the public is referred to as common transaction data. The common transaction data corresponds to transaction settlement information according to the present invention.

<Setting Information of Data Needed for Making Use of Plug-in Software>

The setting information of the data needed for making use of the plug-in software is data necessary for the plug-in software runs. The setting information of the data needed for making use of the plug-in software is exemplified by, e.g., a name (OO magistrate) of software in the case of converting the common transaction data oriented to the software installed into the user terminal 1, a URL (URL-B) of a transaction data converting site for converting the common transaction data and an automating procedure for adding the converting destination data to a database of the software installed into the user terminal 1, wherein a setting method is a method of setting these items of setting information in a key of a registry [HKEY_CURREN_USER¥Software¥SETTLEMENT PLUG-IN] for setting the plug-in software. Herein, the phrase “converting the common transaction data oriented to the software installed into the user terminal 1” connotes that the common transaction data is converted into a format enabling the software installed into the user terminal 1 such as the accounting software and the housekeeping accounts book software to handle the common transaction data. Further, the “transaction data converting site” connotes a site for converting the common transaction data into the format enabling the software installed into the user terminal 1 such as the accounting software and the housekeeping accounts book software to handle the common transaction data. Still further, the “converting destination data” connotes data after converting the common transaction data into data oriented to the software installed into the user terminal 1 such as the accounting software and the housekeeping accounts book software. The converting destination data corresponds to converting settlement information according to the present invention.

The user terminal 1 is installed with the software such as the accounting software and the housekeeping accounts book software corresponding to the plug-in software. The software to be installed may be stored in the recording medium such as the flexible disc, the magneto-optic disc, the CD-ROM, the CD-R/W and the DVD and may also be downloaded from on the network 4.

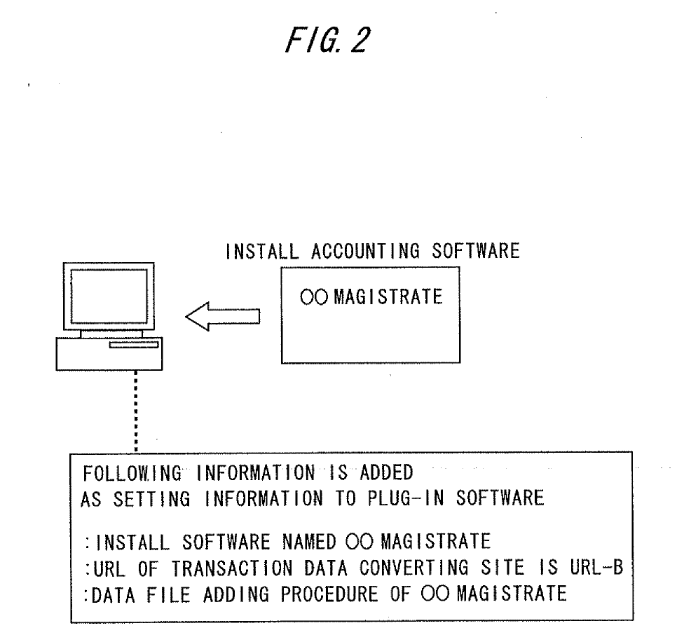

When installing the accounting software and the housekeeping accounts book software corresponding to the plug-in software, a name of the installed software, a URL of the transaction data converting site for converting the common transaction data into the data oriented to the installed software and a data file adding procedure of the installed software, are set as the setting information of the settlement plug-in software. FIG. 2 is a diagram showing an example of adding the setting information of the settlement plug-in software. In FIG. 2, when installing a OO magistrate defined as the accounting software, pieces of information showing that [Install software named the OO magistrate], [URL of the transaction data converting site is URL-B] and [Data file adding procedure of the OO magistrate], are set in the settlement plug-in software.

The server 2 builds up the transaction site for conducting the transaction with the user terminal 1, thereby providing online transactions such as net sales and net banking carried out on the network 4. The server 2, when the online transaction with the user terminal 1 is performed, receives a remittance from a bank account and settles an account by a credit card. Then, the server 2 converts the transaction data into the common transaction data and thus provides the common transaction data to the user terminal 1.

The server 3 provides a service for converting the common transaction data into the data oriented to the software installed into the user terminal 1. The transaction data converting site of the server 3 receives the common transaction data from the user, then converts the received common transaction data into the data oriented to the software installed into the user terminal 1, and provides the converted data to the user terminal 1. Further, if the software installed into the user terminal 1 has a plurality of versions, the common transaction data is converted according to each of the plural versions.

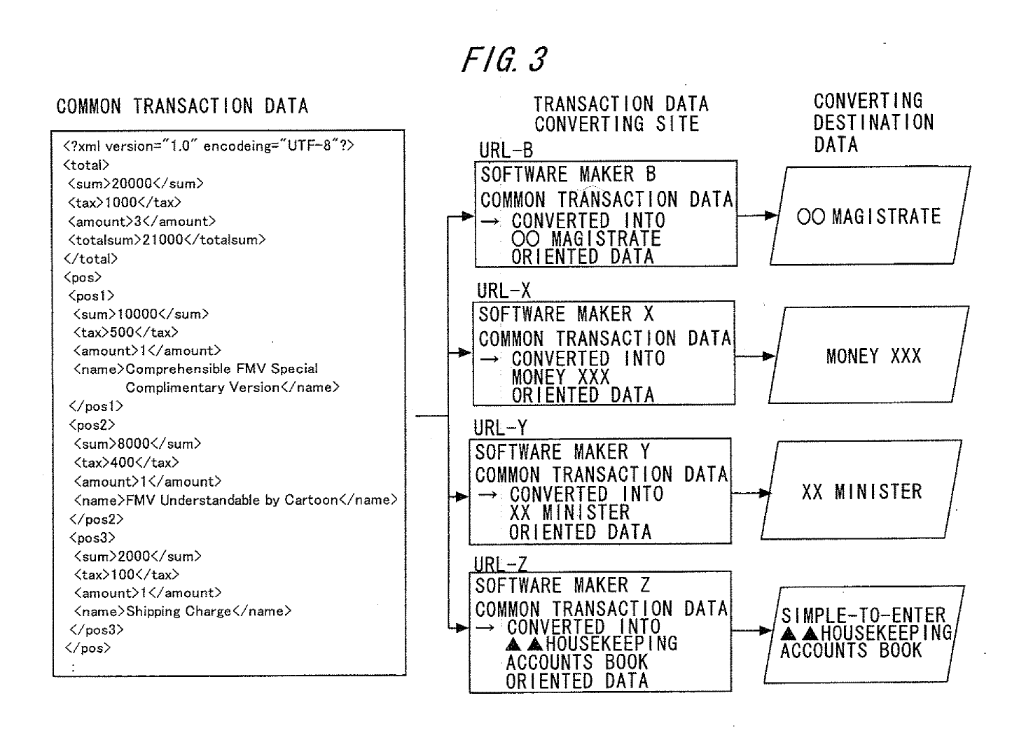

FIG. 3 is a diagram illustrating a case in which the transaction data converting site of the server 3 converts the common transaction data into the converting destination data. In FIG. 3, the common transaction data is described in the markup language such as the HTML and the XML. Herein, the common transaction data is converted into the converting destination data via the converting service provided by the server 3. FIG. 3 shows that the common transaction data has a content of purchasing one piece of [Comprehensible FMV Special Complimentary Version] priced at 10,500 Yen including tax and one piece of [FMV Understandable by Cartoon] priced at 8,400 Yen including tax, and having 2,100 Yen calculated as a shipping charge. The user terminal 1 transmits the common transaction data to the transaction data converting site of the server 3, and the transaction data converting site of the server 3, which has received the common transaction data, converts the data format in the received data into the data format oriented to the software installed into the user terminal 1.

For example, if a name of the software provided by the software maker B and URL-B of the software maker B are set as the setting information of the data needed for using the plug-in software, the user terminal 1 transmits the common transaction data to the transaction data converting site specified by URL-B. Then, the transaction data converting site receiving the common transaction data converts the data format in the received common transaction data into the data format oriented to the software provided by the software maker B. Herein, the data format in the common transaction data is converted into the data format oriented to the software named the [OO magistrate] provided by the software maker B.

The transaction data converting site of the server 3 is specified by the unique URL, and the user terminal 1 designates the URL of the transaction data converting site of the server 3 via the Browser and is thereby enabled to access the server 3. Each of the servers 2 and 3 is a general type of computer having a communication function, and its configuration and operation are widely known, so that the explanations thereof are omitted.

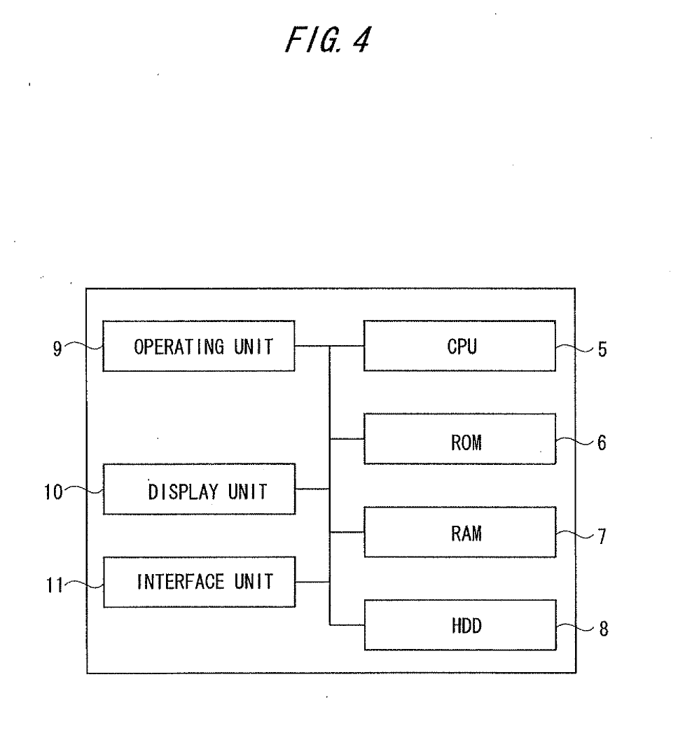

FIG. 4 is a diagram illustrating a hardware configuration of the user terminal 1. The user terminal 1 is constructed of a CPU (Central Processing Unit) 5, a ROM (Read Only Memory) 6, a RAM (Random Access Memory) 7, a HDD (Hard Disk Drive) 8, an operating unit 9, a display unit 10 and an interface unit 11. These components are connected to each other via a bus.

The CPU 5 executes a variety of processes based on a program stored in the RON 6. The CPU 5 establishes a communication line by linking with the server 2 or 3 through the interface unit 11. The interface unit 11 includes a communication device such as a MODEM and a terminal adaptor, and controls communications with the servers 2 and 3. Further, the CPU 5 can access the servers 2 and 3 via the interface unit 11. A process using the network communications is executed on the Browser. The Browser executes the process in such a way that the CPU 5 runs a Browser program stored in the ROM 6.

The ROM 6 is stored with the Browser program for configuring the Browser and a communication program for establishing and maintaining the communications with the servers 2 and 3. Further, the ROM 6 is stored with OS (Operating System) for realizing an input/output of the file and control of the user terminal 1. Still further, the ROM 6 is stored with a program and parameters necessary for the user terminal 1 to function. The RAM 7 is stored with data necessary for the CPU 5 to operate and an application program executed by the CPU 5. The HDD 8 performs control of reading from and writing to a hard disk (unillustrated) stored with the application program and the necessary data. The operating unit 9 is exemplified by, e.g., a keyboard and a mouse and is operated when inputting a predetermined command and required data. The display unit 10 includes, e.g., a display device such as a CRT (Cathode Ray Tube), a liquid crystal display and a plasma display, a sound output device like a loudspeaker, and an output device like a printer device. For example, various categories of screen data transmitted by the server 2 are decoded by the Browser and displayed on the display device. The user can input authentication information, and can browse and select want-to-purchase electronic commercial articles according to the variety of screens displayed on the display device.

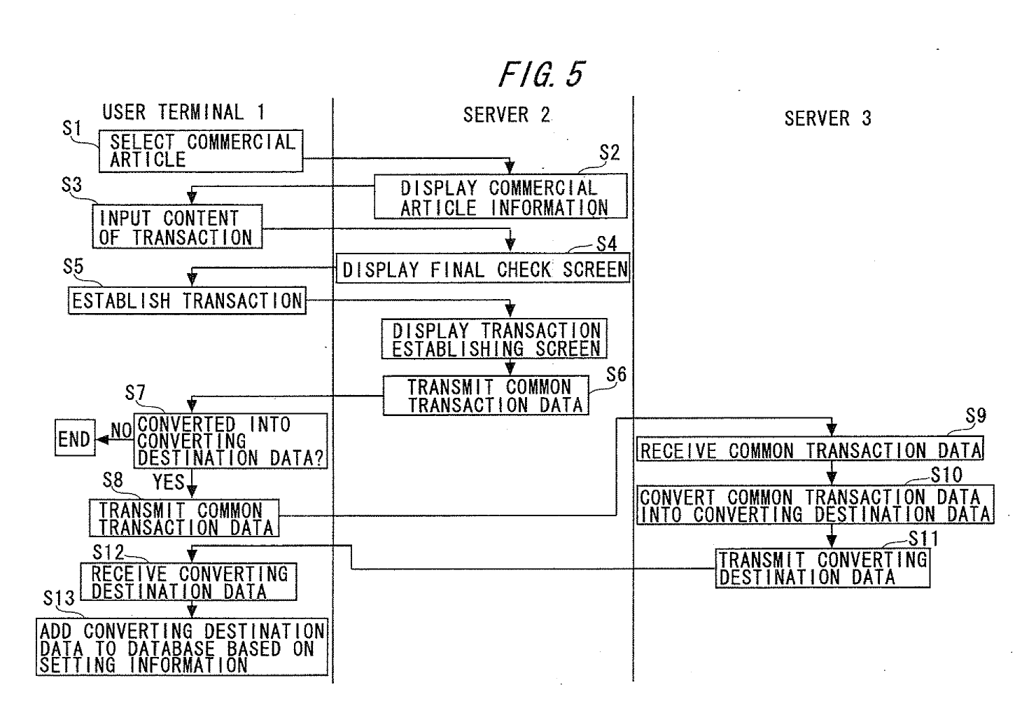

FIG. 5 is a flowchart showing a common transaction data converting process. To begin with, the user accesses the online transaction site provided by the server 2 via the network 4 by use of the user terminal 1, and conducts the online transaction. By way of an online transaction method, the user selects a desired commercial article by employing the Browser within the user terminal 1 (S1). Next, the server 2 displays the information on the commercial article selected by the user (S2). Then, the user inputs a content of the transaction via the Browser (S3). Items of input information are, e.g., a name of purchaser, a delivery destination, a telephone number, an e-mail address and a settlement method. The server 2 displays a final check screen (S4).

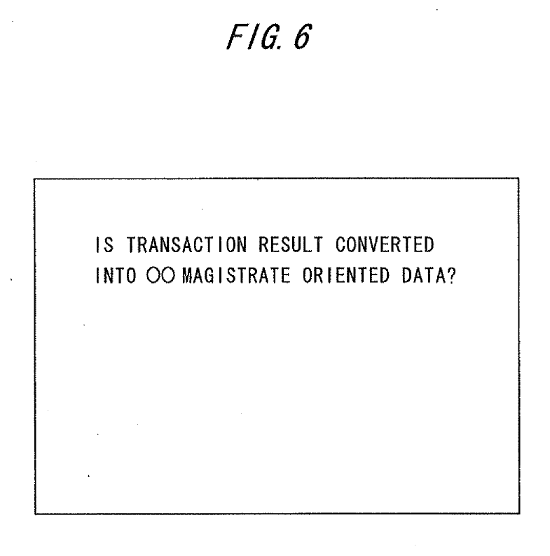

Next, the user establishes the transaction via the Browser (S5). When the user establishes the transaction via the Browser, the server 2 displays a transaction establishment screen. Then, the server 2 transmits the common transaction data to the user terminal 1 (S6). At this time, the server 2 may simply transmit the common transaction data without being aware of what the software installed into the user terminal 1 is. Then, the user terminal 1 receives the common transaction data from the server 2. When receiving the common transaction data, it is ascertained by the user via the monitor whether the common transaction data is to be converted into the converting destination data or not (S7). If plural pieces of accounting software and housekeeping accounts book software have been installed into the user terminal 1, it is ascertained by the user whether the data is converted for every piece of installed software or not. FIG. 6 shows an example of the screen for ascertaining whether the common transaction data is converted into the data oriented to the software installed into the user terminal 1.

If the user consents to convert the common transaction data into the converting destination data, the user terminal 1 transmits the common transaction data to the transaction data converting site of the server 3 (S8). Herein, the user terminal 1 transmits the data to the transaction data converting site of the server 3 on the basis of the URL of the transaction data converting site, which is added as the setting information of the settlement plug-in software. Whereas if the user does not consent to convert the common transaction data into the converting destination data, the user terminal 1 terminates the common transaction data converting process.

If the user consents to convert the common transaction data into the converting destination data and if the user terminal 1 transmits the common transaction data to the transaction data converting site of the server 3, the transaction data converting site of the server 3 receives the common transaction data transmitted by the user terminal 1 (S9). Then, the transaction data converting site of the server 3 converts the common transaction data into the converting destination data (S10). Herein, the common transaction data is converted, based on the specifications opened to the public, into the data oriented to the software installed into the user terminal 1. Next, the transaction data converting site of the server 3 transmits the converting destination data to the user terminal 1 (S11). Subsequently, the user terminal 1 receives the converting destination data transmitted by the transaction data converting site of the server 3 (S12). Next, the user terminal 1 adds the converting destination data to the database of the software installed into the user terminal 1 in accordance with the setting information of the data needed for utilizing the plug-in software (S13).

In the manner described above, the user terminal 1 receives the common transaction data from the server 2 and transmits the common transaction data to the transaction data converting site of the server 3. The transaction data converting site is provided for every piece of software such as the accounting software and the housekeeping accounts book software utilized by the user. Each transaction data converting site converts the received common transaction data into the data oriented to the data format prescribed by each transaction data converting site, and transmits the converted data to the user terminal 1. According to the present embodiment, when the user uses the software installed into the user terminal 1 after finishing the online settlement, the user terminal 1 comes to a status in which a transaction result has already been inputted in the way of being oriented to the software installed into the user terminal 1. Accordingly, the user has no necessity of re-inputting by himself or herself the transaction result received from the online transaction site as the data oriented to the software installed into the user terminal 1. Hence, the re-inputting operation can be omitted, and a mis-input with which the re-input accompanies can be prevented. Moreover, it is feasible to gain more of efficiency of the processes by the user who utilizes the multiple pieces of software.

### MODIFIED EXAMPLES

The embodiment discussed above has exemplified the system, wherein the individual transaction data converting site is provided for every piece of software such as the accounting software and the housekeeping accounts book software utilized by the user, and the transaction data converting site is identified by the URL and then utilized. As a substitute for this scheme, however, any inconvenience may not be caused if one transaction data converting site converts the common transaction data into the converting destination data oriented to the software such as the accounting software and the housekeeping accounts book software utilized by the user.

### Example 1

For instance, if the single software maker provides the plural types of accounting software, the transaction data converting site designated by URL-A may convert the common transaction data into the converting destination data different for every type of accounting software. In this case, as to the data transmitted to the site designated by URL-A from the user terminal a, identifying information for specifying the type of the software installed into the user terminal 1 may be transmitted together with the common transaction data.

### Example 2

For instance, the single transaction data converting site designated by URL-C may convert the common transaction data into the converting destination data oriented to the software provided by two or more software makers. In this case, as to the data transmitted to the transaction data converting site designated by URL-C from the user terminal 1, the identifying information for specifying the type of the software installed into the user terminal 1 may be transmitted together with the common transaction data.

Further, the embodiment discussed above has exemplified the system, in which the single server builds up the transaction data converting site that converts the common transaction data into the converting destination data. In place of this scheme, however, any inconvenience may not be caused if the transaction data converting site is built up by two or more servers. For example, if the user terminal 1 transmits the common transaction data to the transaction data converting site designated by URL-D, the server of the site receiving the common transaction data may be differentiated from the server that converts the common transaction data into the converting destination data. In this case, the user terminal 1 transmits the common transaction data to the transaction data converting site designated by URL-D, and the server different from the server of the site receiving the common transaction data converts the common transaction data into the converting destination data. Then, the server of the transaction data converting site designated by the URL-D may transmit the converting destination data to the user terminal 1. The server of the site receiving the common transaction data is connected via the communication line to the server that converts the common transaction data into the converting destination data, whereby the common transaction data can be transmitted and received therebetween.

<Readable-by-Computer Recording Medium>>

A program for making a computer realize any one of the functions can be recorded on a recording medium readable by the computer. Then, the computer is made to read and execute the program on this recording medium, whereby the function can be provided.

Herein, the recording medium readable by the computer, etc. connotes a recording medium capable of storing information such as data, programs, etc. electrically, magnetically, optically, mechanically or by chemical action, which can be read from the computer. Among these recording mediums, for example, a flexible disc, a magneto-optic disc, a CD-ROM, a CD-R/W, a DVD, a DAT, an 8 mm tape, a memory card, etc. are given as those demountable from the computer. Further, a hard disc, a ROM (Read-Only Memory), etc. are given as the recording mediums fixed within the computer.

What is claimed is:

1. An information processing device communicating with a first server that provides transaction settlement information and communicating with a second server that converts the transaction settlement information into a predetermined format, said device comprising:
a receiving unit receiving the transaction settlement information from said first server;
a recording unit recording the received transaction settlement information;
a identifying information recording unit recording identifying information for identifying said second server;
a settlement information transmitting unit transmitting the transaction settlement information to said second server on the basis of the recorded identifying information;
a receiving unit receiving, from said second server, converted settlement information converted by said second server into the predetermined format from the transaction settlement information; and
a recording unit recording the thus-received converted settlement information.

2. The information processing device according to claim 1, further comprising a querying unit querying a user about whether the transaction settlement information is converted into the predetermined format or not,
wherein said settlement information transmitting unit, if the user consents that the transaction settlement information is converted into the predetermined format, transmits the transaction settlement information to said second server, but does not transmit, whereas if the user does not consent that the transaction settlement information is converted into the predetermined format, the transaction settlement information to said second server.

3. The information processing device according to claim 2, further comprising a prompting unit prompting the user to select said second server as a transmitting destination of the transaction settlement information,
wherein said settlement information transmitting unit transmits the transaction settlement information to said second server selected by the user but does not transmit the transaction settlement information to said second server that is not selected by the user.

4. The information processing device according to claim 1, wherein the predetermined format is a format that is processing-enabled by software dealing with the transaction settlement information.

5. The information processing device according to claim 1, wherein said identifying information recording unit records the identifying information corresponding to the predetermined format, and
said second server is provided for every predetermined format.

6. The information processing device according to claim 1, wherein the identifying information is identifying information on the Internet, and
said second server is a Web server that provides services on the Internet.

7. A method executed by an information processing device communicating with a first server that provides transaction settlement information and communicating with a second server that converts the transaction settlement information into a predetermined format, said method comprising:
a step of receiving the transaction settlement information from said first server;
a step of recording the received transaction settlement information;
a step of recording identifying information for identifying said second server;
a settlement information transmitting step of transmitting the transaction settlement information to said second server on the basis of the recorded identifying information;
a step of receiving, from said second server, converted settlement information converted by said second server into the predetermined format from the transaction settlement information; and
a step of recording the thus-received converted settlement information.

8. The method according to claim 7, further comprising a step of querying a user about whether the transaction settlement information is converted into the predetermined format or not,
wherein said settlement information transmitting step includes, if the user consents that the transaction settlement information is converted into the predetermined format, transmitting the transaction settlement information to said second server, and transmitting, whereas if the user does not consent that the transaction settlement information is converted into the predetermined format, none of the transaction settlement information to said second server.

9. The method according to claim 8, further comprising a step of prompting the user to select said second server as a transmitting destination of the transaction settlement information,
wherein said settlement information transmitting step includes transmitting the transaction settlement information to said second server selected by the user and transmitting none of the transaction settlement information to said second server that is not selected by the user.

10. The method according to claim 7, wherein the predetermined format is a format that is processing-enabled by software dealing with the transaction settlement information.

11. The method according to claim 7, wherein said identifying information recording step includes recording the identifying information corresponding to the predetermined format, and
said second server is provided for every predetermined format.

12. The method according to claim 7, wherein the identifying information is identifying information on the Internet, and
said second server is a Web server that provides services on the Internet.

13. A computer readable storage medium storing an executable-by-computer program executed by an information processing device communicating with a first server that provides transaction settlement information and communicating with a second server that converts the transaction settlement information into a predetermined format, said program comprising:
a step of receiving the transaction settlement information from said first server;
a step of recording the received transaction settlement information;
a step of recording identifying information for identifying said second servers;
a settlement information transmitting step of transmitting the transaction settlement information to said second server on the basis of the recorded identifying information;
a step of receiving, from said second server, converted settlement information converted by said second server into the predetermined format from the transaction settlement information; and
a step of recording the thus-received converted settlement information.

14. The computer readable storage medium storing an executable-by-computer program according to claim 13, further comprising a step of querying a user about whether the transaction settlement information is converted into the predetermined format or not,
wherein said settlement information transmitting step includes, if the user consents that the transaction settlement information is converted into the predetermined format, transmitting the transaction settlement information to said second server, and transmitting, whereas if the user does not consent that the transaction settlement information is converted into the predetermined format, none of the transaction settlement information to said second server.

15. The computer readable storage medium storing an executable-by-computer program according to claim 14, further comprising a step of prompting the user to select said second server as a transmitting destination of the transaction settlement information,
wherein said settlement information transmitting step includes transmitting the transaction settlement information to said second server selected by the user and transmitting none of the transaction settlement information to said second server that is not selected by the user.

16. The computer readable storage medium storing an executable-by-computer program according to claim 13, wherein the predetermined format is a format that is processing-enabled by software dealing with the transaction settlement information.

17. The computer readable storage medium storing an executable-by-computer program according to claim 13, wherein said identifying information recording step includes recording the identifying information corresponding to the predetermined format, and
said second server is provided for every predetermined format.

18. The computer readable storage medium storing an executable-by-computer program according to claim 13, wherein the identifying information is identifying information on the Internet, and
said second server is a Web server that provides services on the Internet.
